(19) United States
(12) Patent Application Publication
(10) Pub. No.: US 2017/0208074 A1
(43) Pub. Date: Jul. 20, 2017

(54) ACCESS DETECTION OF AN UNAUTHORIZED DEVICE

(71) Applicant: TOYOTA MOTOR ENGINEERING & MANUFACTURING NORTH AMERICA, INC., Erlanger, KY (US)

(72) Inventors: Ming Michael Meng, Novi, MI (US); Wilson-Boon Siang Khoo, Canton, MI (US)

(73) Assignee: TOYOTA MOTOR ENGINEERING & MANUFACTURING NORTH AMERICA, INC., Erlanger, KY (US)

(21) Appl. No.: 15/001,650

(22) Filed: Jan. 20, 2016

(51) Int. Cl. H04L 29/06; H04L 29/08

(52) U.S. Cl. CPC H04L 63/107; H04L 67/12

(57) ABSTRACT

Systems and methods include a data communications module (DCM) having a control area network (CAN) bus configured to be connected to an OBD port. A DLC having a high DLC branch line is connected to a high main bus line of the CAN bus and a low DLC branch line is connected to a low main bus line of the CAN bus. The DCM also includes a DDC connected between the DLC and the low main bus line of the CAN bus. The DDC is configured to transmit a signal to a telematics ECU when an external device connects with the OBD port. The DCM also includes a network access device (NAD) configured to initiate a signal to one or more notification centers when the external device connects with the OBD port.

### BACKGROUND

Many vehicles have an onboard diagnostic (OBD) system configured to communicate a potential vehicle problem or malfunction, such as a diagnostic trouble code (DTC) to the vehicle owner or operator and/or to an automotive technician. An OBD port is configured to receive and connect to an outside device for the purpose of accessing vehicle diagnostic information. “See Ljubinko Miljkovic et al. System to view automobile diagnostic information. U.S. Publication Number US 2014/1017886 A1, incorporated herein by reference in its entirety.”

An OBDII port specifies the type of diagnostic connector and its pinout, the electrical signaling protocols available, and the messaging format. It also provides a candidate list of vehicle parameters to monitor along with how to encode the data for each of the vehicle parameters.

The “background” description provided herein is for the purpose of generally presenting the context of the disclosure. Work of the presently named inventors, to the extent it is described in this background section are neither expressly nor impliedly admitted as prior art against the present invention. In addition, aspects of the description which may not otherwise qualify as prior art at the time of filing are neither expressly nor impliedly admitted as prior and against the present invention.

### SUMMARY

Embodiments include an electronic circuit including a data link connector (DLC) having a high DLC branch line connected to a high main bus line and a low DLC branch line connected to a low main bus line. The electronic circuit also includes a device detection circuit (DDC) connected between the DLC and the low main bus line. The DDC is configured to transmit a signal to a pre-determined. ECU when the electronic circuit is closed.

Embodiments also include a data communications module (DCM) having a control area network (CAN) bus configured to be connected to an OBD port. The DCM also includes a DLC having a high DLC branch line connected to a high main bus line of the CAN bus and a low DLC branch line connected to a low main bus line of the CAN bus. The DCM also includes a DDC connected between the DLC and the low main bus line of the CAN bus. The DDC is configured to transmit a signal to a telematics ECU when an external device connects with the OBD port. The DCM also includes a network access device (NAD) configured to initiate a signal to one or more notification centers when the external device connects with the OBD port.

Embodiments also include a method of detecting access of an unauthorized device. The method includes receiving, via a DDC, a communication signal from a CAN bus in response to the unauthorized device connecting to an OBD port. The method also includes transmitting, via a telephone antenna, a first message of the detected access of the unauthorized device to one or more registered mobile devices. The method also includes displaying, via a navigation receiver assembly, a second message of the detected access of the unauthorized device to a display area. The method also includes determining, via a guidance positioning system (GPS) antenna, a location of the DDC.

The foregoing paragraphs have been provided by way of general introduction, and are not intended to limit the scope of the following claims. The described embodiments, together with further advantages, will be best understood by reference to the following detailed description, taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an unauthorized device access detection system according o an embodiment;

FIG. 2 is an operational flowchart of the unauthorized device access detection system according to an embodiment;

FIG. 3 illustrates an OBDII port according to an embodiment;

FIG. 4 illustrates a pin definition according to an embodiment;

FIG. 5A is a block diagram of OBDII connections according to an embodiment;

FIG. 5B illustrates a circuit diagram for a device detection location according to an embodiment;

FIG. 6 is a block diagram illustrating an exemplary electronic device according to an embodiment;

FIG. 7 is a block diagram illustrating an exemplary computing device according to an embodiment;

FIG. 8 is a block diagram of an exemplary data processing system according to an embodiment;

FIG. 9 is a block diagram of an exemplary CPU according to an embodiment; and

FIG. 10 is a flowchart of an exemplary method of detecting access of an unauthorized device according to an embodiment.

### DETAILED DESCRIPTION OF THE EMBODIMENTS

When a device is connected to an OBDII port, the presence of the device is not electronically recognized under a conventional OBD system. Therefore, it may go undetected for several weeks or months until an authorized person attempts to connect an intended device to the OBDII port. Embodiments herein describe systems and methods for identifying and reporting an unauthorized device that is connected to a vehicle OBDII port.

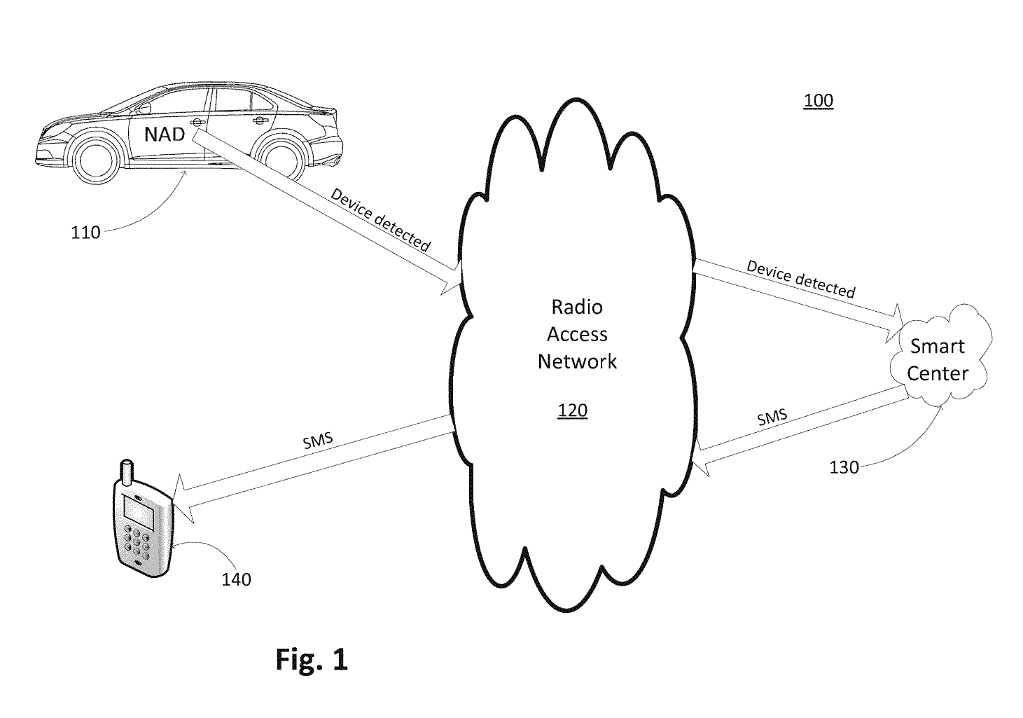

FIG. 1 illustrates an unauthorized device access detection system 100. A vehicle 110 has a DCM, which includes a NAD. The NAD is configured to communicate through a wireless network, such as Radio Access Network (RAN) 120. When an unauthorized device has been connected to the OBDII port, the NAD will initiate a communication to the RAN 120.

After receiving the communication regarding an unauthorized device from the NAD, the RAN 120 sends a communication to a smart center 130. The smart center 130 can be a central communications center for an original equipment manufacturer (OEM), such as an automobile manufacturer. Smart center 130 can include vehicle information such as owner information, vehicle identification number (VIN), and NAD identification.

After receiving the communication regarding an unauthorized device from the RAN 120, the smart center 130 sends a short messaging service (SMS) message to the owner's registered mobile device 140, via the RAN 120 in a first embodiment. The SMS message can be sent directly to the auto display of the vehicle, or to both the owners registered mobile device 140 and to the vehicle auto display. If the smart center 130 has additional mobile devices registered, the SMS message can also be sent to the additional mobile devices. A dashboard indicator, such as an indicator light can be activated to indicate the presence of an unauthorized device connected to the OBDII port. The SMS message contains a header with multiple frames containing data. One or more of the frames can be designated for data pertaining to an unauthorized device connection to the OBDII port.

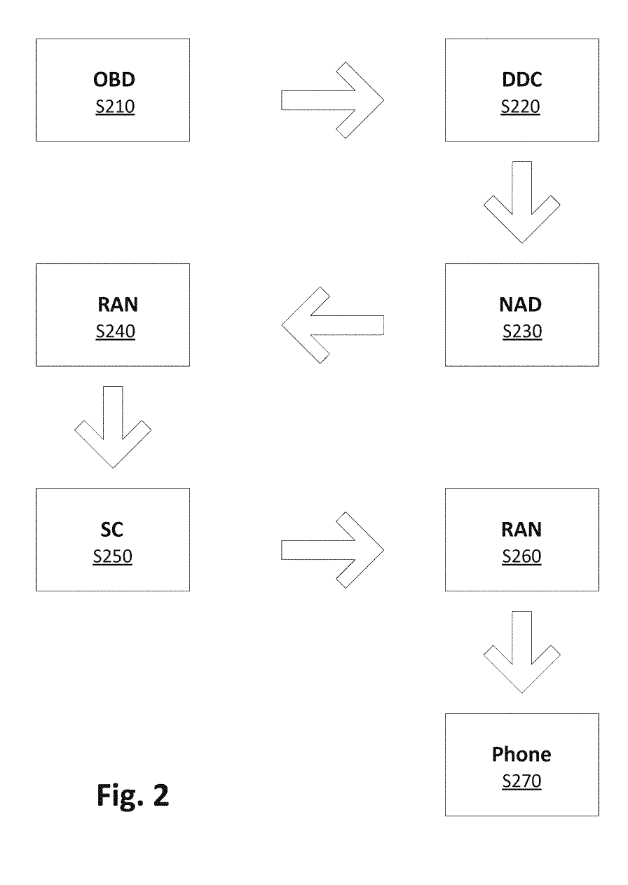

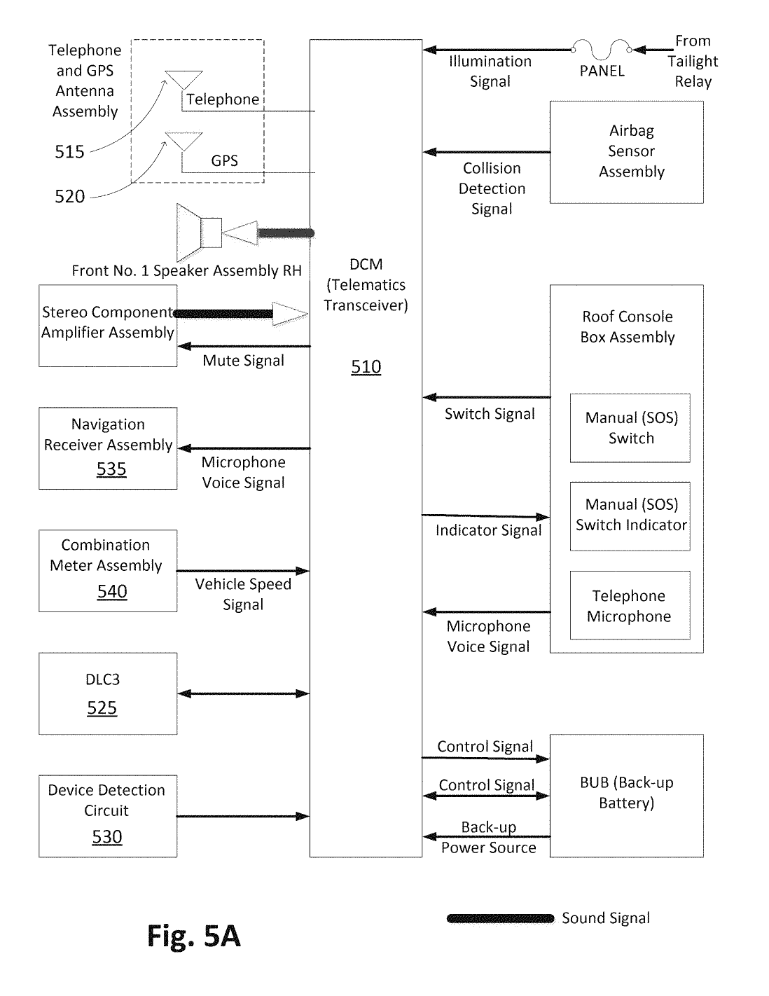

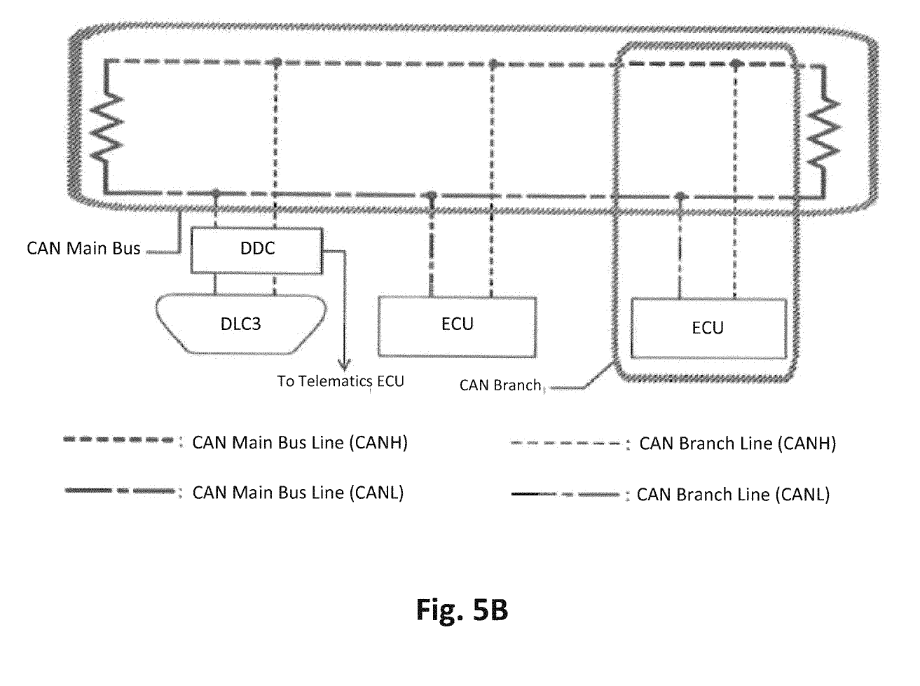

FIG. 2 is an operational flowchart of the unauthorized device access detection system 100. An external device is connected to an OBDII port of vehicle 110 in step S210. The external device is recognized by a device detection circuit (DDC) in step S220. The DDC will be discussed in greater detail herein with reference to FIG. 5B. The detection of the external device by the DDC initiates a communication from the NAD in step S230. The NAD sends the communication to the RAN 120 in step S240, which will be forwarded to the smart center 130 in step S250. After the smart center 130 receives the communication signal and confirms the owner information, the smart center 130 transmits an SMS message to the RAN 120 in step S260. The RAN 120 forwards the SMS message to the owner via a registered mobile device 140, or through the vehicle display or a vehicle indicator in step S270.

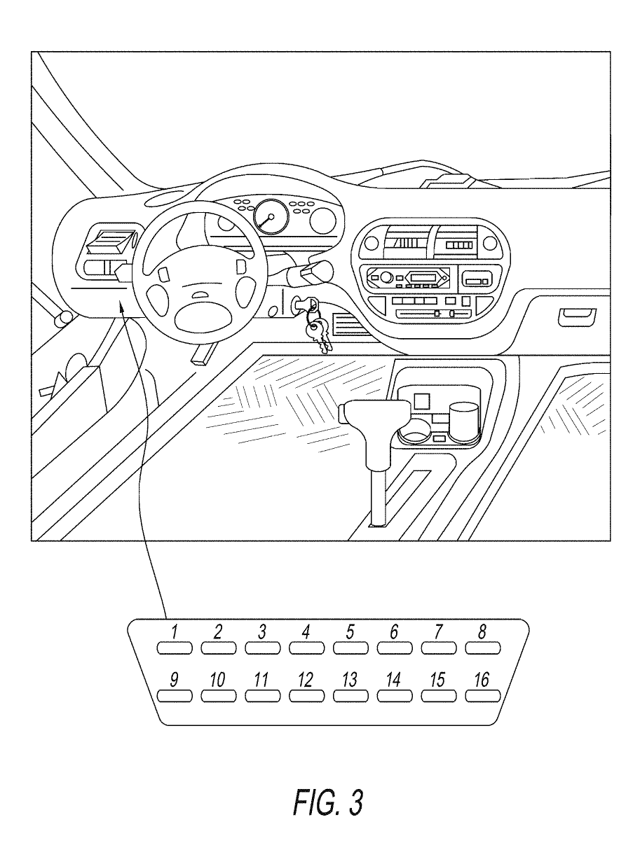

FIG. 3 illustrates an OBDII port, which is configured to be connected with an external device. The OBDII port can be located on or under the dashboard, and can also be located near to the steering wheel. FIG. 3 illustrates sixteen individual connection ports within the OBDII port. However, other connection port numbers and configurations can be used with embodiments described herein.

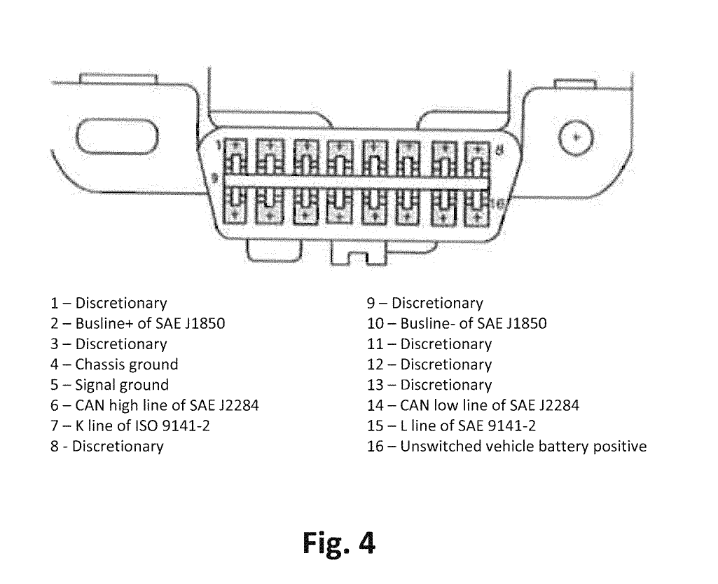

FIG. 4 illustrates a pin definition corresponding to the individual connection ports illustrated in FIG. 3. Each pin has a specific function. An exemplary pin definition is illustrated in FIG. 4. However, other pin configurations and definitions can be used with embodiments described herein.

FIG. 5A is a block diagram of the OBDII connections to the NAD. A DCM 510 includes a telematics transceiver, i.e. the telematics device of the NAD access device. The DCM 510 controls vehicle communication and communication for the RAN 120. A RAN antenna 515 is configured to send and receive telephone communication signals to and from the RAN 120. A GPS antenna 520 is configured to receive GPS signals to provide location information of the vehicle 110. The OBDII port connects to the DCM through a CAN bus of the vehicle network, for example.

A DLC 525 is connected to the DCM 510 through a serial communication line. A DDC 530 is also connected to the DCM 510. The DDC 530 works in conjunction with the DLC 525 to detect an unauthorized device connected to the OBDII port. When the unauthorized device is detected by the DDC 530, a warning signal is sent to the DCM 510. The DCM 510 transmits a signal through the RAN antenna 515. A signal is also transmitted to the OPS antenna 520 to determine a location of vehicle 110.

FIG. 5A also illustrates a navigation receiver assembly 535. In an embodiment, the navigation receiver assembly 535 is an audio display. When an unauthorized device is detected by the DDC 530, a message from the smart center 130 is sent to the navigation receiver assembly 535 for an audio display of a warning message regarding the OBDII port connection of an unauthorized device. The warning message can be displayed via the navigation receiver assembly 535 in addition to or in lieu of a text message to the registered mobile device 140.

FIG. 5A also illustrates a combination meter assembly 540. The combination meter assembly 540 includes, but is not limited to a page or indicator for the vehicle's speed, engine revolutions per minute (RPMs), engine temperature, oil pressure, battery charge, fuel level, seat belt fastening, and door closures. Embodiments described herein include an indicator on the combination meter assembly 540 for an unauthorized device connection to the OBDII port. The smart center 130 sends a warning message signal to the combination meter assembly 540 when an unauthorized device has been detected by the DDC 530. The warning indicator can be a LED that becomes illuminated when a signal is received from the DDC 530.

Embodiments described herein could include notification of an unauthorized device connected to the OBDII port through one or more of a text message notification to an owner's registered mobile device(s) 140, a message and/or audio message sent to the navigation receiver assembly 535, and a signal sent to the combination meter assembly 540. Several other features illustrated in FIG. 5A are self-explanatory.

FIG. 5B illustrates a circuit diagram for a device detection location. A vehicle network, such as a CAN main bus includes a high CAN bus line and a low CAN bus line with a resistor connecting each end of the CAN bus lines. In an embodiment, the two resistors are 120 ohms and form CAN bus terminators. Multiple ECUs are connected to the CAN main bus. The ECUs can range from 50 to 100 in number, for example. The ECUs communicate with each other and also communicate with outside devices through the CAN main bus.

FIG. 5B also illustrates the DLC in connection with the CAN bus lines. In an example, an automotive technician would connect a scanning device to the OBDII port through the DLC connector or an OBDII bus. One or more signals are sent to their associated. ECUs. In another embodiment, the ECU automatically sends a DLC code to the CAN bus. The connected scanning device receives a message or code regarding a detected malfunction. A DDC is connected to the CAN bus lines between the CAN main bus and the DLC. The DDC is also connected to the telematics ECU.

The two resistors are sensing resistors attached to the CAN high line. When there is no device connected to the OBDII port, an open circuit is formed and no current flows through the circuit. When a device is connected to the OBDII port such as an unauthorized device, the circuit closes in order to transmit a communication signal, via a current through the circuit to one or more ECUs. When a device is connected to the OBDII port, the DDC transmits a signal to the telematics DCM.

A dongle is a device that can be connected to the OBDII port. A dongle can be used to connect to another device to provide it with additional functionality. A dongle can also be used to obtain information from a connected system, similar to the device used by an automotive technician to obtain vehicle information. However, other types of dongle devices can be connected to a vehicle's OBDII port to possibly gain vehicle information from one or more ECUs of the vehicle. If an unauthorized dongle has been connected to a vehicle's OBDII port without the owner's consent, the vehicle's electronic system could be jeopardized and/or confidential information contained within the vehicle's electronic system could be obtained. In addition, a dongle can input various signals into the vehicle network, possibly producing erroneous messages or even tampering with various vehicle mechanical systems.

Embodiments herein describe the DDC being configured to notify the owner or operator of a vehicle when a device has been connected to the OBDII port. When a device is connected to the OBDII port, the circuit closes and a current flows through the circuit. The DDC, detects the current, which is sent to an amplifier. The signal is amplified and sent to the telematics DCM 510.

Upon receiving the notification of access by an unauthorized device, via one or more of the embodiments described herein, the owner or operator can obtain immediate assistance to remove the device and determine an extent of breach by the unauthorized device. In addition, safety measures can be included in which the vehicle will not start or operate when an unauthorized device has been connected to the OBDII port.

Measures can also be included to accommodate an intended outside device connection, such as a connection by an automotive technician. The vehicle's smart center 130 can be contacted to allow the automotive technician to access the vehicle's network. In addition, one or more desirable devices can be registered with the vehicle's smart center 130 as authorized devices.

FIGS. 1-5B have been described for implementation within a vehicle to determine when an unauthorized device has connected to a OBDII port of a telematics DCM. However, the DDC can be implemented within other systems in which a notification of a particular action or reaction is desired.

In a first alternative embodiment, multiple manufacturing processes could include a DDC that is configured to close when a process reaches a pre-determined time, temperature, or pressure, for example. Respective sensors could be used to detect the pre-determined time, temperature, and/or pressure. A signal would subsequently be transmitted to the circuit to apply a voltage across the DLC to drive a current and close the circuit. Notification of the closed circuit can be sent to multiple computing devices and/or mobile devices, intercoms, alarms, flashing lights, etc.

In a second alternative embodiment, multiple manufacturing processes could include a DDC that is configured to close when a raw material supply has decreased to a predetermined level and needs to be replenished. A light or motion sensor could be used to detect a pre-determined level of raw material supply. A signal would subsequently be transmitted to the circuit to apply a voltage across the DLC to drive a current and close the circuit. Notification of the closed circuit can be sent to multiple computing devices and/or mobile devices, intercoms, etc. In addition, the closed circuit could transmit a signal to cease the associated process to avoid damaging any equipment.

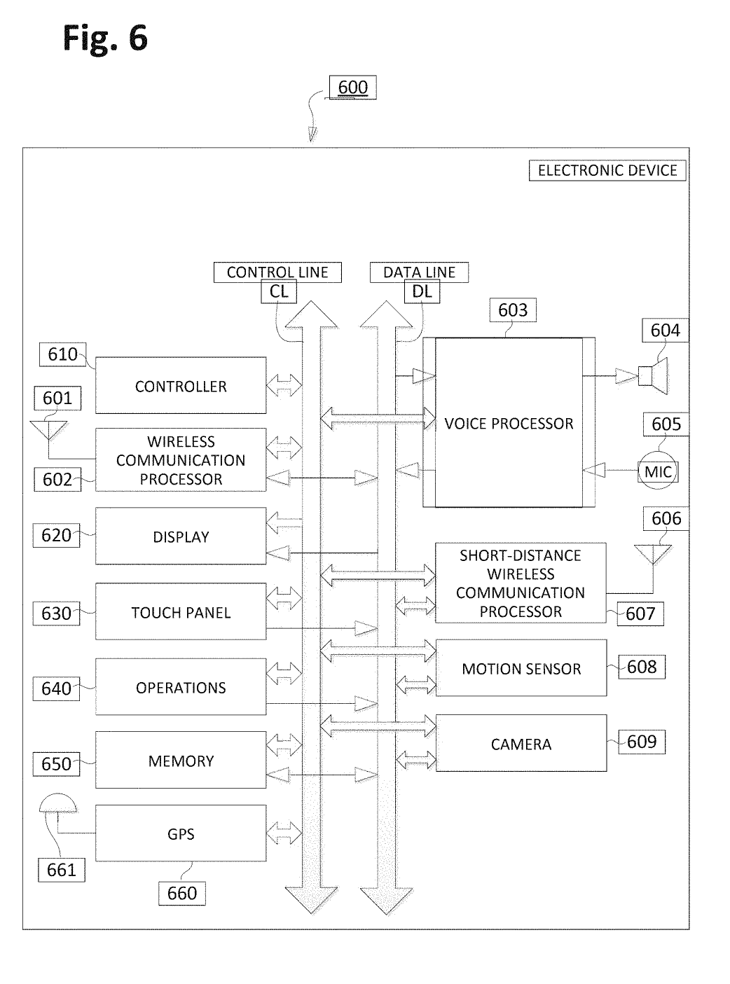

FIG. 6 is a block diagram illustrating an exemplary electronic device 600 that could be used to implement one or more embodiments of the present disclosure, such as mobile device 140. In some embodiments, electronic device 600 can be a smartphone. In other embodiments, electronic device 600 can be a laptop, a tablet, a server, an e-reader, a camera, a navigation device, etc. The exemplary electronic device 600 of FIG. 6 includes a controller 610 and a wireless communication processor 602 connected to an antenna 601. A speaker 604 and a microphone 605 arc connected to a voice processor 603.

The controller 610 can include one or more central processing units (CPUs), and can control each element in the electronic device 600 to perform functions related to communication control, audio signal processing, control for the audio signal processing, and other kinds of signal processing. The controller 610 can perform these functions by executing instructions stored in a memory 650. Alternatively, or in addition to the local storage of the memory 650, the functions can be executed using instructions stored on an external device accessed on a network or on a non-transitory computer-readable medium.

The memory 650 includes but is not limited to Read Only Memory (ROM), Random Access Memory (RAM), or a memory array including a combination of volatile and non-volatile memory units. The memory 650 can be utilized as working memory by the controller 610 while executing the processes and algorithms of the present disclosure. Additionally, the memory 650 can be used for long-term storage, e.g., of image data and information related thereto.

The electronic device 600 includes a control line CL and data line DL as internal communication bus lines. Control data to/from the controller 610 can be transmitted through the control line CL. The data line DL can be used for transmission of voice data, display data, etc.

The antenna 601 transmits/receives electromagnetic wave signals between base stations for performing radio-based communication, such as the various forms of cellular telephone communication. The wireless communication processor 602 controls the communication performed between the electronic device 600 and other external devices via the antenna 601. For example, the wireless communication processor 602 can control communication between base stations for cellular phone communication.

The speaker 604 emits an audio signal corresponding to audio data supplied from the voice processor 603. The microphone 605 detects surrounding audio and converts the detected audio into an audio signal. The audio signal can then be output to the voice processor 603 for further processing. The voice processor 603 demodulates and/or decodes the audio data read from the memory 650 or audio data received by the wireless communication processor 602 and/or a short-distance wireless communication processor 607. Additionally, the voice processor 603 can decode audio signals obtained by the microphone 605.

The exemplary electronic device 600 can also include a display 620, a touch panel 630, an operations key 640, and a short-distance communication processor 607 connected to an antenna 606. The display 620 can be a Liquid Crystal Display (LCD), an organic electroluminescence display panel, or another display screen technology. In addition to displaying still and moving image data, the display 620 can display operational inputs, such as numbers or icons which can be used for control of the electronic device 600. The display 620 can additionally display a GUI for a user to control aspects of the electronic device 600 and/or other devices. Further, the display 620 can display characters and images received by the electronic device 600 and/or stored in the memory 650 or accessed from an external device on a network. For example, the electronic device 600 can access a network such as the Internet and display text and/or images transmitted from a Web server.

The touch panel 630 can include a physical touch panel display screen and a touch panel driver. The touch panel 630 can include one or more touch sensors for detecting an input operation on an operation surface of the touch panel display screen. The touch panel 630 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus can include a conductive material at least at the tip of the stylus. The sensors included in the touch panel 630 can detect when the stylus approaches/contacts the operation surface of the touch panel display (similar to the case in which a finger is used for the touch operation).

According to aspects of the present disclosure, the touch panel 630 can be disposed adjacent to the display 620 (e.g., laminated) or can be formed integrally with the display 620. For simplicity, the present disclosure assumes the touch panel 630 is formed integrally with the display 620 and therefore, examples discussed herein describe touch operations being performed on the surface of the display 620 rather than the touch panel 630. However, the skilled artisan will appreciate that this is not limiting.

For simplicity, the present disclosure assumes the touch panel 630 is a capacitance-type touch panel technology. However, it should be appreciated that aspects of the present disclosure can easily be applied to other touch panel types (e.g., resistance-type touch panels) with alternate structures. According to aspects of the present disclosure, the touch panel 630 can include transparent electrode touch sensors arranged in the X-Y direction on the surface of transparent sensor glass.

The touch panel driver can be included in the touch panel 630 for control processing related to the touch panel 630, such as scanning control. For example, the touch panel driver can scan each sensor in an electrostatic capacitance transparent electrode pattern in the X-direction and Y-direction and detect the electrostatic capacitance value of each sensor to determine when a touch operation is performed. The touch panel driver can output a coordinate and corresponding electrostatic capacitance value for each sensor. The touch panel driver can also output a sensor identifier that can be mapped to a coordinate on the touch panel display screen. Additionally, the touch panel driver and touch panel sensors can detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. Signals can be transmitted by the touch panel driver, e.g. in response to a detection of a touch operation, in response to a query from another element based on timed data exchange, etc.

The touch panel 630 and the display 620 can be surrounded by a protective casing, which can also enclose the other elements included in the electronic device 600. According to aspects of the disclosure, a position of the user's fingers on the protective casing (but not directly on the surface of the display 620) can be detected by the touch panel 630 sensors. Accordingly, the controller 610 can perform display control processing described herein based on the detected position of the user's fingers gripping the casing. For example, an element in an interface can be moved to a new location within the interface (e.g., closer to one or more of the fingers) based on the detected finger position.

Further, according to aspects of the disclosure, the controller 610 can be configured to detect which hand is holding the electronic device 600, based on the detected finger position. For example, the touch panel 630 sensors can detect a plurality of fingers on the left side of the electronic device 600 (e.g., on an edge of the display 620 or on the protective casing), and detect a single finger on the right side of the electronic device 600. In this exemplary scenario, the controller 610 can determine that the user is holding the electronic device 600 with his/her right hand because the detected grip pattern corresponds to an expected pattern When the electronic device 600 is held only with the right hand.

The operation key 640 can include one or more buttons or similar external control elements, which can generate an operation signal based on a detected input by the user. In addition to outputs from the touch panel 630, these operation signals can be supplied to the controller 610 for performing related processing and control. According to aspects of the disclosure, the processing and/or functions associated with external buttons and the like can be performed by the controller 610 in response to an input operation on the touch panel 630 display screen rather than the external button, key, etc. In this way, external buttons on the electronic device 600 can be eliminated in lieu of performing inputs via touch operations, thereby improving water-tightness.

The antenna 606 can transmit/receive electromagnetic wave signals to/from other external apparatuses, and the short-distance wireless communication processor 607 can control the wireless communication performed between the other external apparatuses. Bluetooth, IEEE 802.11, and near-field communication (NFC) are non-limiting examples of wireless communication protocols that can be used for inter-device communication via the short-distance wireless communication processor 607.

The electronic device 600 can include a motion sensor 608. The motion sensor 608 can detect features of motion (i.e., one or more movements) of the electronic device 600. For example, the motion sensor 608 can include an accelerometer to detect acceleration, a gyroscope to detect angular velocity, a geomagnetic sensor to detect direction, a geo-location sensor to detect location, etc., or a combination thereof to detect motion of the electronic device 600. According to aspects of the disclosure, the motion sensor 608 can generate a detection signal that includes data representing the detected motion. For example, the motion sensor 608 can determine a number of distinct movements in a motion, a number of physical shocks on the electronic device 600, a speed and/or acceleration of the motion, or other motion features. The detected motion features can be included in the generated detection signal. The detection signal can be transmitted, e.g., to the controller 610, whereby further processing can be performed based on data included in the detection signal. The motion sensor 608 can work in conjunction with a GPS 660. The GPS 660 detects the present position of the electronic device 600. The information of the present position detected by the GPS 660 is transmitted to the controller 610. An antenna 661 is connected to the GPS 660 for receiving and transmitting signals to and from a GPS satellite.

Electronic device 600 can include a camera 609, which includes a lens and shutter for capturing photographs of the surroundings around the electronic device 600. In an embodiment, the camera 609 captures surroundings of an opposite side of the electronic device 600 from the user. The images of the captured photographs can be displayed on the display panel 620. A memory saves the captured photographs. The memory can reside within the camera 609 or it can be part of the memory 650. The camera 609 can be a separate feature attached to the electronic device 600 or it can be a built-in camera feature.

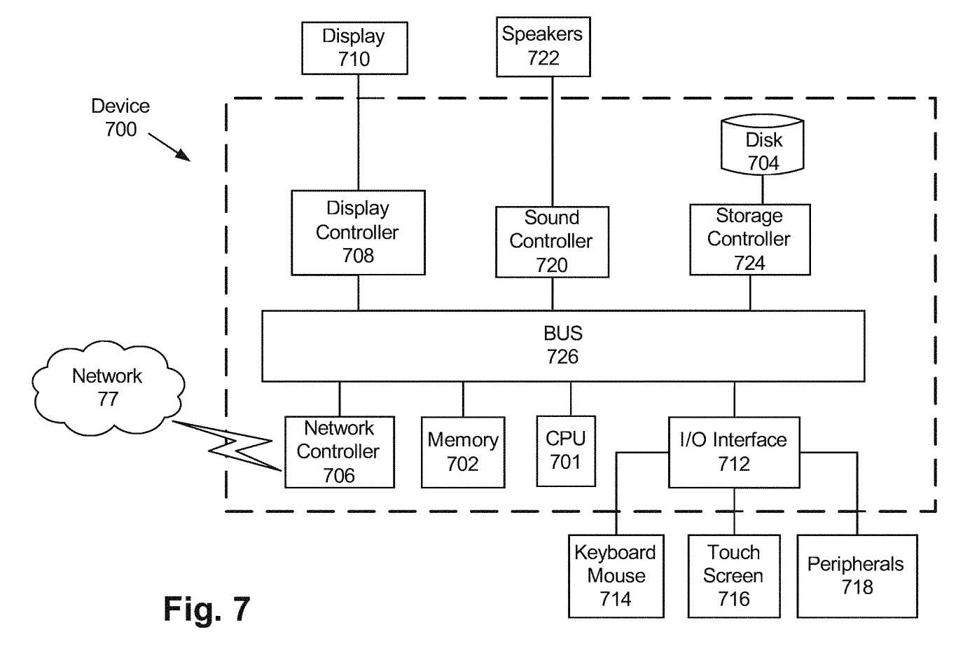

A hardware description of a computing device 700 used in accordance with exemplary embodiments is described with reference to FIG. 7. One or more features described above with reference to electronic device 600 of FIG. 6 can be included in computing device 700 described herein. Computing device 700 could be used to implement one or more embodiments of the present disclosure, such as the NAD in vehicle 110 or one or more computing devices and/or servers used in smart center 130.

In FIG. 7, the computing device 700 includes a CPU 701 which performs the processes described herein. The process data and instructions may be stored in memory 702. These processes and instructions may also be stored on a storage medium disk 704 such as a hard drive (HDD) or portable storage medium or may be stored remotely. Further, the claimed embodiments are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claimed embodiments may be provided as a utility application, background daemon, or component of an operating system, or combination thereof, executing in conjunction with CPU 701 and an operating system. Examples of an operating system include Microsoft Windows 7, UNIX, Solaris, LINUX, Apple MAC-OS, and other systems known to those skilled in the art.

CPU 701 may be a Xenon or Core processor from Intel of America or an Opteron processor from AMD of America, or may be other processor types that would be recognized by one of ordinary skill in the art. Alternatively, the CPU 701 may be implemented on an FPGA, ASIC, PLD or using discrete logic circuits, as one of ordinary skill in the art would recognize. Further, CPU 701 may be implemented as multiple processors cooperatively working in parallel to perform the instructions of the inventive processes described above.

The computing device 700 in FIG. 7 also includes a network controller 706, such as an Intel Ethernet PRO network interface card from Intel Corporation of America, for interfacing with network 77. As can be appreciated, the network 77 can be a public network, such as the Internet, or a private network such as an LAN or WAN network, or any combination thereof and can also include PSTN or ISDN sub-networks, The network 77 can also be wired, such as an Ethernet network, or can he wireless such as a cellular network including EDGE, 3G and 4G wireless cellular systems. The wireless network can also be WiFi, Bluetooth, or any other wireless form of communication that is known.

The computing device 700 further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface 712 also connects to a variety of peripherals 718 including printers and scanners, such as an OfficeJet or DeskJet from Hewlett Packard. A sound controller 720 is also provided in the computing device, such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the computing device 700. A description of the general features and functionality of the display 710, keyboard and/or mouse 714, as well as the display controller 708, storage controller 724, network controller 706, sound controller 720, and general purpose I/O interface 712 are omitted herein for brevity.

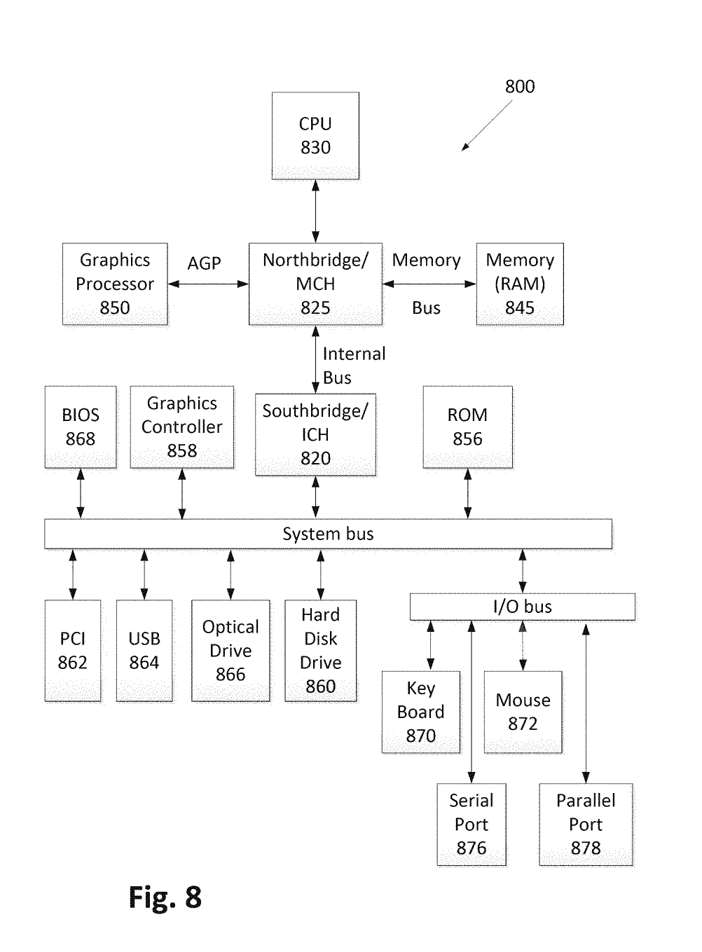

The exemplary circuit elements described in the context of the present disclosure can be replaced with other elements and structured differently than the examples provided herein Moreover, circuitry configured to perform features described herein can be implemented in multiple circuit units (e.g., chips), or the features can be combined in circuitry on a single chipset, as shown in FIG. 8. The chipset of FIG. 8 can be implemented in conjunction with either electronic device 600 or computing device 700 described herein with reference to FIGS. 6 and 7, respectively.

FIG. 8 shows a schematic diagram of a data processing system, according to aspects of the disclosure described herein for performing a menu navigation. The data processing system is an example of a computer in which code or instructions implementing the processes of the illustrative embodiments can be located.

In FIG. 8, data processing system 800 employs an application architecture including a north bridge and memory controller application (NB/MCH) 825 and a south bridge and input/output (I/O) controller application (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU 830 can contain one or more processors and even can be implemented using one or more heterogeneous processor systems.

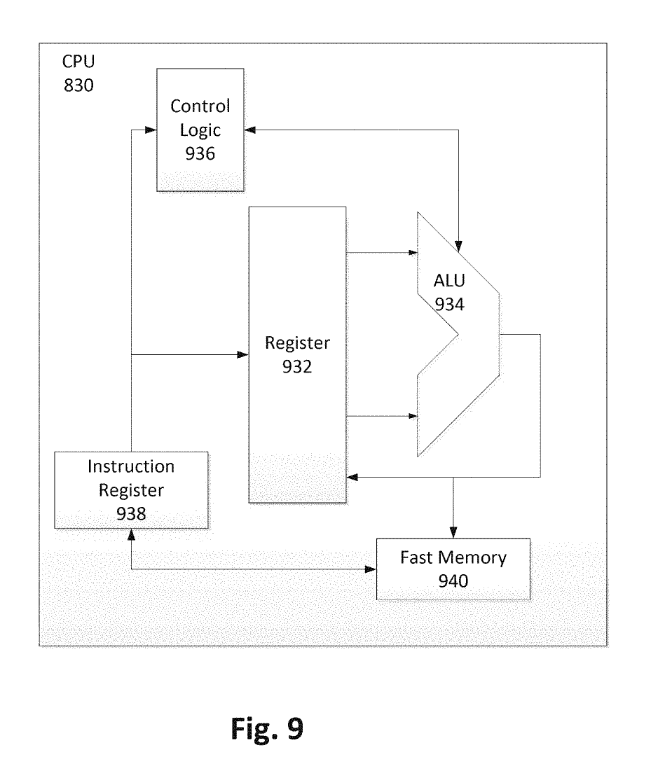

For example, FIG. 9 shows one implementation of CPU 830. In one implementation, an instruction register 938 retrieves instructions from a fast memory 940. At least part of these instructions are fetched from an instruction register 938 by a control logic 936 and interpreted according to the instruction set architecture of the CPU 830. Part of the instructions can also be directed to a register 932. In one implementation the instructions are decoded according to a hardwired method, and in another implementation the instructions are decoded according to a microprogram that translates instructions into sets of CPU configuration signals that are applied sequentially over multiple clock pulses.

After fetching and decoding the instructions, the instructions are executed using an arithmetic logic unit (ALU) 934 that loads values from the register 932 and performs logical and mathematical operations on the loaded values according to the instructions. The results from these operations can be fed back into the register 932 and/or stored in a fast memory 940.

According to aspects of the disclosure, the instruction set architecture of the CPU 830 can use a reduced instruction set computer (RISC), a complex instruction set computer (CISC), a vector processor architecture, or a very long instruction word (VLIW) architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor; a Power architecture processor by, e.g., IBM; a SPARC architecture processor by Sun Microsystems or by Oracle; or other known CPU architectures.

Referring again to FIG. 8, the data processing system 800 can include the SB/ICH 820 being coupled through a system bus to an I/O Bus, a read only memory (ROM) 856, universal serial bus (USB) port 864, a flash binary input/output system (BIOS) 868, and a graphics controller 858, PCI/PCIe devices can also be coupled to SB/ICH 820 through a PCI bus 862.

The PCI devices can include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein can also be executed by various distributed components of a system. For example, one or more processors can execute these system functions, wherein the processors are distributed across multiple components communicating in a network. The distributed components can include one or more client and server machines, which can share processing, such as a cloud computing system, in addition to various human interface and communication devices (e.g., display monitors, smart phones, tablets, personal digital assistants (PDAs)). The network can be a private network., such as a LAN or WAN, or can be a public network, such as the Internet. Input to the system can be received via direct user input and received remotely either in real-time or as a batch process. Additionally, some implementations can be performed on modules or hardware not identical to those described. Accordingly, other implementations are within the scope that can be claimed.

The functions and features described herein may also be executed by various distributed components of a system. For example, one or more processors may execute these system functions, wherein the processors are distributed across multiple components communicating in a network. For example, distributed performance of the processing functions can be realized using grid computing or cloud computing. Many modalities of remote and distributed computing can be referred to under the umbrella of cloud computing, including: software as a service, platform as a service, data as a service, and infrastructure as a service. Cloud computing generally refers to processing performed at centralized locations and accessible to multiple users who interact with the centralized processing locations through individual terminals.

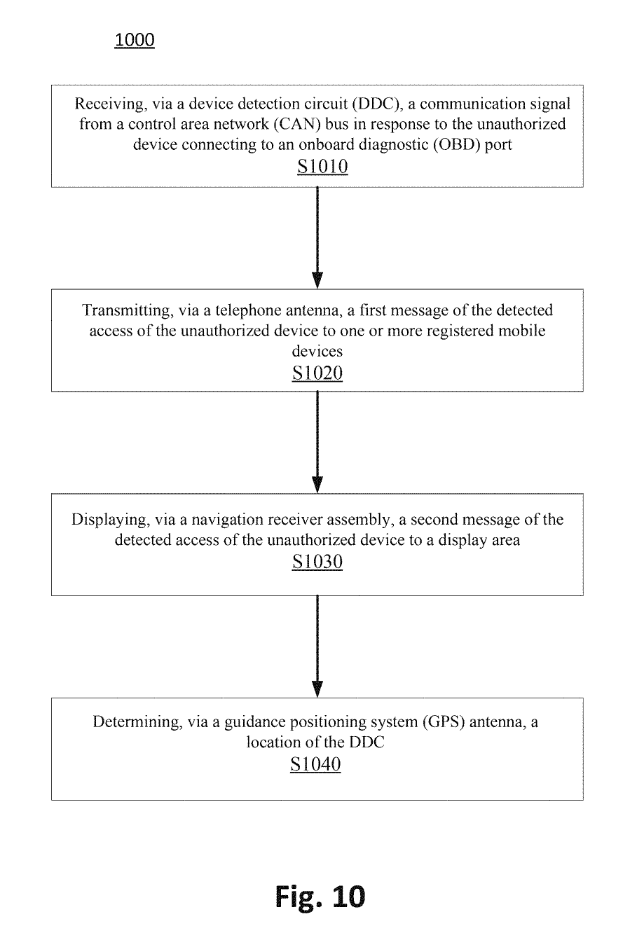

FIG. 10 illustrates an exemplary flowchart for performing a method according to aspects of the present disclosure. The hardware description above, exemplified by any one of the structural examples illustrated in FIG. 6, 7, or 8, constitutes or includes specialized corresponding structure that is programmed or configured to perform the method illustrated in FIG. 10. For example, the method illustrated in FIG. 10 may be completely performed by the circuitry included in the single device shown in FIG. 6 or 7, or the chipset as illustrated in FIG. 8. The method may also be completely performed in a shared manner distributed over the circuitry of any plurality of the devices.

FIG. 10 is a flowchart for an exemplary method 1000 of detecting access of an unauthorized device. A communication signal is received, via a DDC from a CAN bus in response to the unauthorized device connecting to an OBD port in step S1010. A first message of the detected access of the unauthorized device is transmitted, via a telephone antenna, to one or more registered mobile devices in step S1020. A second message of the detected access of the unauthorized device is displayed, via a navigation receiver assembly, to a display area in step S1030. A location of the DDC is determined, via a GPS antenna in step S1040.

Method 1000 can also include a step of activating, via a combination meter assembly, an indicator configured to represent the detected access of the unauthorized device. Method 1000 can also include a step of transmitting, via the DDC, a signal to a telematics ECU when the communication signal from the CAN bus has been received. 1000 od 1100 can also include a step of closing, via a DLC, an electronic circuit having the DDC when the communication signal from the CAN bus has been received.

The foregoing discussion discloses and describes merely exemplary embodiments of the present disclosure. As will be understood by those skilled in the art, the present disclosure may be embodied in other specific forms without departing from the spirit or essential characteristics thereof. Accordingly, the present disclosure is intended to be illustrative, but not limiting of the scope of the disclosure, including the claims. The disclosure, including any readily discernible variants of the teachings herein, defines in part, the scope of the foregoing claim terminology such that no inventive subject matter is dedicated to the public.

1. An electronic circuit, comprising:
a high main bus line;
a low main bus line;
a data link connector (DLC) having a high DEC branch line connected to the high main bus line and a low DLC branch line connected to the low main bus line; and
a device detection circuit (DDC) connected between the DLC and the low main bus line, the DDC configured to transmit a signal to a pre-determined electronic control unit (ECU) when the electronic circuit is closed.

2. The electronic circuit of claim 1, wherein the electronic circuit is configured to close when a device has connected to a port of the pre-determined ECU.

3. The electronic circuit of claim 2, wherein the electronic circuit is further configured to transmit a signal to a radio access network (RAN) when the device has connected to the port of the pre-determined ECU.

4. The electronic circuit of claim 1, wherein the pre-determined ECU comprises a telematics ECU of a data communications module (DCM).

5. The electronic circuit of claim 1, wherein the DDC is configured to initiate transmission of a message to one or more registered mobile devices when the electronic circuit is closed.

6. The electronic circuit of claim 1, wherein the DDC is configured to initiate a location identification of the DDC when the electronic circuit is closed.

7. The electronic circuit of claim 1, wherein the DDC is configured to initiate a signal to a combination meter assembly when the electronic circuit is closed.

8. The electronic circuit of claim 1, further comprising:
a first resistor connected to a first end of the high main bus line and a first end of the low main bus line; and
a second resistor connected to a second end of the high main bus line and a second end of the low main bus line.

9. The electronic circuit of claim 1, further comprising:
one or more electronic control units (ECUs), each ECU having a high ECU branch line connected to the high main bus line and a low ECU branch line connected to the low main bus line.

10. A data communications module (DCM), comprising:
a control area network (CAN) bus configured to be connected to an onboard diagnostic (OBD) port;
a data link connector (DLC) having a high DLC branch line connected to a high main bus line of the CAN bus and a low DLC branch line connected to a low main bus line of the CAN bus;
a device detection circuit (DDC) connected between the DLC and the low main bus line of the CAN bus, the DDC configured to transmit a signal to a telematics electronic control unit (ECU) when an external device connects with the OBD port; and
a network access device (NAD) configured to initiate a signal to one or more notification centers when the external device connects with the OBI) port.

11. The DCM of claim 10, wherein the CAN bus is configured to close to provide a current flow through the CAN bus when the external device connects with the OBD port.

12. The DCM of claim 10, wherein the DDC is configured to initiate transmission of a message, via the NAD to one or more registered mobile devices when the CAN bus is closed.

13. The DCM of claim 10, wherein the DDC is configured to initiate a location identification of the DCM, via the NAD when the CAN bus is closed.

14. The DCM of claim 10, wherein the DDC is configured to initiate a signal to a combination meter assembly, via the NAD when the CAN bus is closed.

15. The DCM of claim 10, further comprising:
one or more electronic control units (ECUs), each ECU having a high ECU branch line connected to the high main bus line of the CAN bus and a low ECU branch line connected to the low main bus line of the CAN bus.

16. A method of detecting access of an unauthorized device, the method comprising:
receiving, via a device detection circuit (DDC), a communication signal from a control area network (CAN) bus in response to the unauthorized device connecting to an onboard diagnostic (OBD) port;
transmitting, via a telephone antenna, a first message of the detected access of the unauthorized device to one or more registered mobile devices;
displaying, via a navigation receiver assembly, a second message of the detected access of the unauthorized device to a display area; and
determining, via a guidance positioning system (GPS) antenna, a location of the DDC.

17. The method of claim 16, further comprising:
activating, via a combination meter assembly, an indicator configured to represent the detected access of the unauthorized device.

18. The method of claim 16, further comprising:
transmitting, via the DDC, a signal to a telematics electronic control unit (ECU) when the communication signal from the CAN bus has been received.

19. The method of claim 16, further comprising:
closing, via a data link connector (DLC), an electronic circuit having the DDC when the communication signal from the CAN bus has been received.
